(19) United States
(12) Patent Application Publication
(10) Pub. No.: US 2015/0070736 A1
(43) Pub. Date: Mar. 12, 2015

(54) IMAGE PROCESSING APPARATUS, IMAGE PROCESSING METHOD, AND PROGRAM

(71) Applicant: CANON KABUSHIKI KAISHA, Tokyo (JP)

(72) Inventor: Hiroshi Yoneyama, Kawasaki-shi (JP)

(21) Appl. No.: 14/477,686

(22) Filed: Sep. 4, 2014

(30) Foreign Application Priority Data
Sep. 9, 2013 (JP) 2013-186434

(51) Int. Cl. H04N 1/00; H04N 1/46

(52) U.S. Cl. CPC H04N 1/00023; H04N 1/00005; H04N 1/00015; H04N 1/00039; H04N 1/00068; H04N 1/46; H04N 2201/0001; H04N 2201/0094
USPC 358/504

(57) ABSTRACT

According to a result of comparing a first color mode acquired when a first layout obtained by aggregating a plurality of pieces of input image data is employed, with a second color mode acquired when a second layout is employed, the second layout being obtained by aggregating, among the plurality of pieces of input image data, image data that has not been determined as obtained by reading a blank (e.g., by aggregating image data determined as having print information while not aggregating pieces of image data determined as having no print information), an image processing apparatus, an image processing method and/or a computer-readable storage medium for use with same according to the present invention(s) determines that the first or second layout is to be employed.

### BACKGROUND OF THE INVENTION

1. Field of the Invention

The present invention relates to an image processing apparatus for determining whether image data to be processed is image data having print information or image data having no print information.

2. Description of the Related Art

An image reading apparatus such as a digital copying machine uses a technique for fixing the position of an optical system and reading an image while conveying a document by an automatic document conveyance device (an auto document feeder (ADF)) (a skimming-through method).

Conventionally, even if a document printed on both sides and a document printed only on one side are mixed together, a multifunction peripheral having an automatic document conveyance device reads both sides of each document.

This method, however, reads even a blank surface of a document, which is the back side of a document printed on only one side. As a result, the blank having no print information is read, which leads to processing unnecessary data. This causes the unnecessary consumption of paper and the unnecessary consumption of power.

In response, Japanese Patent Application Laid-Open No. 2010-178377 discusses a technique for deleting image data determined as a blank using a blank detection function for detecting whether or not a read document is a blank having no print information, thereby reducing unnecessary printing and the unnecessary consumption of paper and toner.

The Japanese Patent Application Laid-Open No. 2010-178377 discusses a blank determination method for detecting an edge portion in image data read from a document and determining, based on the proportion of the amount of detected edge to the total number of pixels, whether or not the document is a blank having no print information.

Further, Japanese Patent Application Laid-Open No. 2005-27088 discusses a method of, when a document is copied using a blank detection technique and a blank sheet has been detected, stopping an output. In Japanese Patent Application Laid-Open No. 2005-27088, if the blank sheet has been detected in reading a document image, the printing of the blank sheet is stopped, and a user is notified of the detection of the blank sheet. This prevents the unnecessary printing of a blank. Hereinafter, this function will be referred to as a “blank skip printing function”.

Meanwhile, there is a system where a charging device using a coin and a prepaid card is connected to an image forming apparatus, and the process of charging for a printing process such as copying is performed. Such a system is used, for example, when a print service is provided to a large number of unspecified users in a store such as a convenience store, or when the numbers of print sheets used in a company are managed distinctively on a department-by-department basis.

Specifically, a user who wishes to use a copy service inserts money required for a printing process into a coin vending machine in advance or pays money using a prepaid card.

Then, if the user has set various copy parameters (the number of documents, the number of copies, the sheet size, and the monochrome/color setting) and given an instruction to perform printing, the presence of a balance meeting the printing fee according to the set parameters is confirmed, and then, a printing operation is started. At this time, if the balance of the amount of inserted money is insufficient, the printing process is canceled. For example, Japanese Patent Application Laid-Open No. 2000-352910 discusses a method of, if the balance of the amount of inserted money is insufficient for a certain function for copying, displaying in a shading manner a function key in an operation unit, thereby preventing an input using the key.

Further, a digital copying machine has a page aggregate function for laying out a plurality of documents on an image memory according to the output sheet size and printing out the laid out documents. This is the function of aggregating a plurality of documents on a single output sheet and copying the documents.

In charged copying using the page aggregate function, however, if the blank skip printing function is simultaneously used, a user may need to pay a higher fee than when the blank skip function is not used, depending on the combination of documents. In charged copying, generally, the printing fee for a color page is higher than the printing fee for a monochrome page. In the example of FIG. 10, the printing fee for an A4-size color page is 50 yen, and the printing fee for an A4-size monochrome page is 10 yen. If documents are arranged in an order 1000 in FIG. 10 and copied in a 2-in-1 page aggregate setting, the total price is 70 yen. If, however, the blank skip printing function discussed in Japanese Patent Application Laid-Open No. 2005-27088 is enabled in this case, the second sheet, which is a monochrome page in the above case, is treated as a color page. Thus, the total price is 110 yen. As described above, the print price when blank skip is enabled may be higher than the print price when a blank is not skipped.

Further, a similar problem arises also when the number of pages allowed to be printed within a certain period is set for each user or each department in a company. Generally, in terms of printing costs, the number of color pages allowed to be printed is set to be smaller than the number of monochrome pages allowed to be printed. Thus, print settings for making the number of color print pages as small as possible are desirable for the user. For example, if documents are arranged in the order 1000 in FIG. 10 and copied in the 2-in-1 page aggregate setting, the number of pages to be printed is made up of one color page and two monochrome pages. If, however, the blank skip printing function discussed in Japanese Patent Application Laid-Open No. 2005-27088 is enabled, the number of pages to be printed is made up of two color pages and one monochrome page. As described above, although the total number of pages to be printed is the same, namely three pages, the number of monochrome pages to be printed decreases, while the number of color pages to be printed increases. This provides undesirable results for the user.

### SUMMARY OF THE INVENTION

According to an aspect of the present invention, an image forming apparatus includes a determination unit configured to determine whether each of a plurality of pieces of input image data is image data obtained by reading a blank, an aggregate unit configured to, in order to lay out any two or more pieces of image data among the plurality of pieces of input image data, on a single sheet, aggregate the two or more pieces of image data, a judgment unit configured to judge a color mode of the two or more pieces of image data aggregated by the aggregate unit, an acquisition unit configured to acquire a first color mode, which is a result obtained by the judgment unit judging the color mode of the two or more pieces of image data when a first layout obtained by the aggregate unit aggregating the plurality of pieces of input image data is employed, and configured to acquire a second color mode, which is a result obtained by the judgment unit judging the color mode of the two or more pieces of image data when a second layout obtained by the aggregate unit aggregating, among the plurality of pieces of input image data, image data that has not been determined by the determination unit as obtained by reading a blank is employed, and a determining unit configured to, according to a result of comparing the first color mode acquired by the acquisition unit with the second color mode acquired by the acquisition unit, determine that the first layout or the second layout is to be employed.

According to the present invention, when aggregate printing is performed, it is possible to avoid blank skip that increases a charged price.

Further features of the present invention will become apparent from the following description of exemplary embodiments with reference to the attached drawings.

### BRIEF DESCRIPTION OF THE DRAWINGS

FIG. 1 is a diagram illustrating an example of the external appearance of a copying machine.

FIG. 2 is a diagram illustrating an exemplary structure of a scanner unit when performing a skimming-through operation.

FIG. 3 is a block diagram illustrating an exemplary configuration of a controller.

FIG. 4 is a diagram illustrating an exemplary configuration of an operation unit.

FIG. 5 is a block diagram illustrating an exemplary configuration of a scanner IF image processing unit.

FIG. 6 is a block diagram illustrating an exemplary configuration of a blank detection unit.

FIGS. 7A and 7B are block diagrams illustrating examples of a histogram generation unit and an edge information generation unit.

FIG. 8 is a block diagram illustrating an example of a histogram analysis unit.

FIG. 9 is a block diagram illustrating an example of an edge information analysis unit.

FIG. 10 is a diagram illustrating an example of the sequence of documents when the application of blank skip to charged copying using page aggregate increases the charged price.

FIG. 11 is a diagram illustrating an example of a page aggregate setting screen.

FIG. 12 is a diagram illustrating an example of a blank skip printing mode setting screen.

FIG. 13 is a flow chart (having a first part shown in FIG. 13A and a second part shown in FIG. 13B) illustrating the flow of charged copying.

FIG. 14 is a flow chart illustrating the flow of a document scanning process.

FIG. 15 is a flow chart illustrating the flow for calculating the total amount of money required for printing.

FIG. 16 is a flow chart illustrating the flow for calculating the total amount of money required when a blank skip printing mode is enabled.

FIG. 17 is a flow chart illustrating the flow for calculating the total amount of money required when the blank skip printing mode is disabled.

FIG. 18 is a diagram illustrating an example of the display of expected print prices when the blank skip printing mode is enabled and when the blank skip printing mode is disabled.

FIG. 19 is a flow chart illustrating the flow for switching to determine whether or not the blank skip printing mode is to be automatically enabled based on the amount of inserted money.

### DESCRIPTION OF THE EMBODIMENTS

Various exemplary embodiments, features, and aspects of the invention will be described in detail below with reference to the drawings.

<External Appearance of Copying Machine>

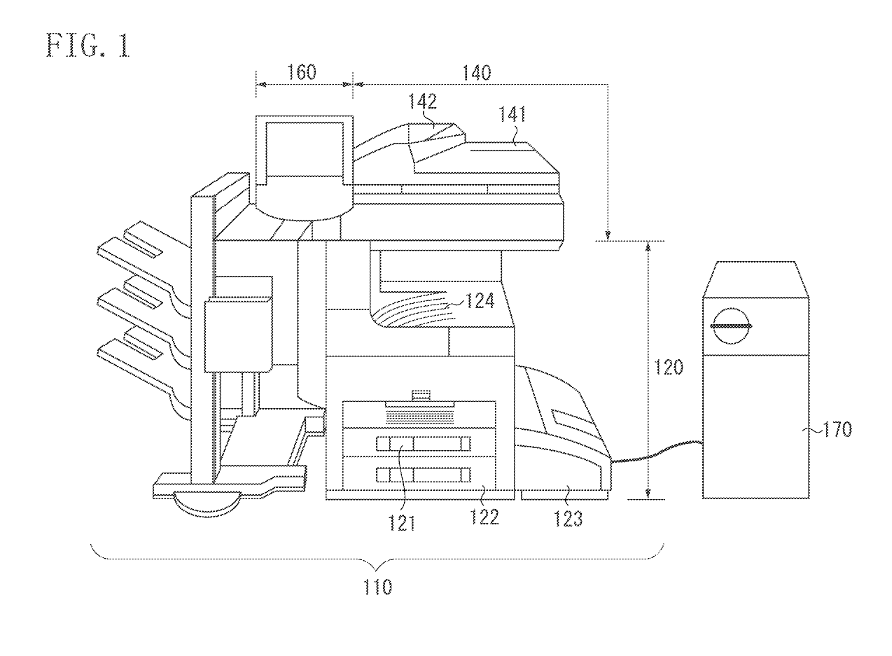

FIG. 1 is a diagram illustrating an example of the external appearance of a copying machine. The entire apparatus includes a copying machine 110 and a coin vending machine 170.

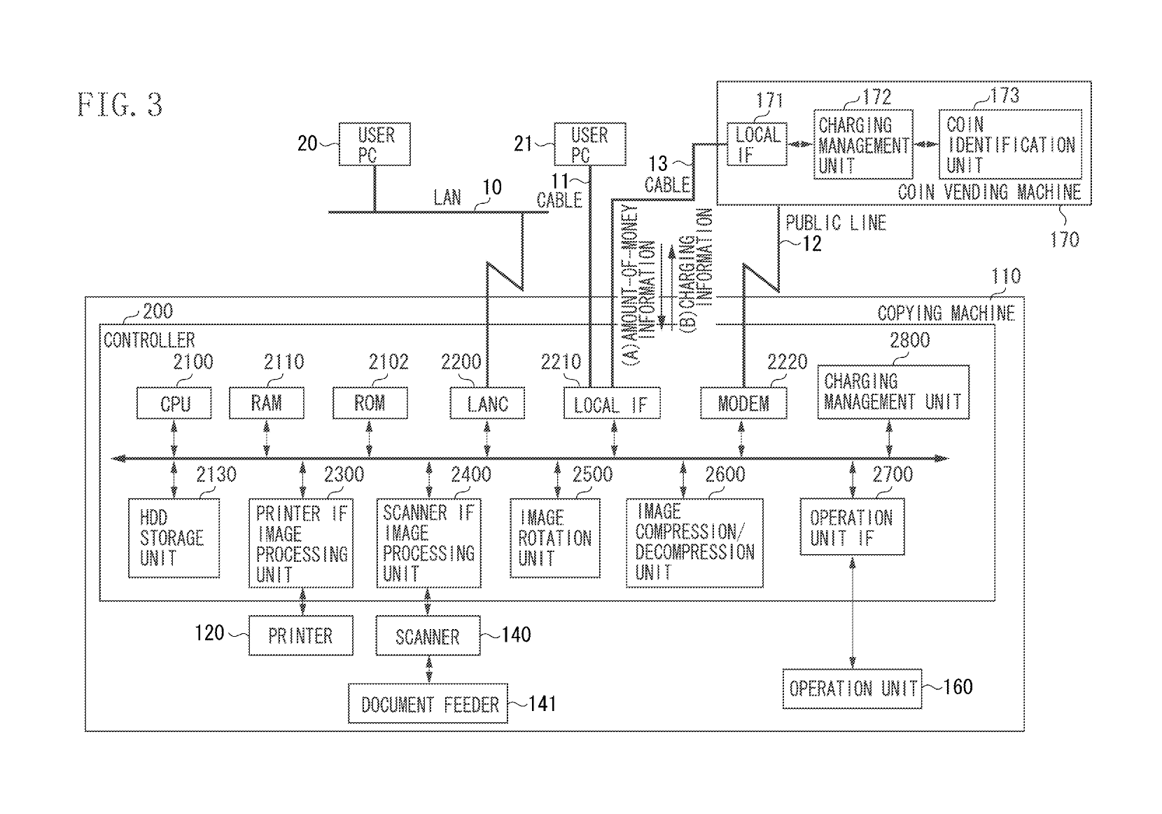

A scanner unit 140, which is an image reading unit, inputs to a linear image sensor (a charge-coupled device (CCD) sensor) the reflected light obtained by causing an illumination lamp to emit light to perform exposure scanning on an image on a document, thereby converting information about the image into an electric signal. The scanner unit 140 further converts the electric signal into luminance signals of red (R), green (G), and blue (B) colors and outputs the luminance signals as image data to a controller 200 in FIG. 3.

Documents are set on a tray 142 of a document feeder 141. When a user has given an instruction through an operation unit 160 to start reading the documents, the controller 200 sends a document reading instruction to the scanner unit 140. When the document reading instruction has been received, the scanner unit 140 feeds the documents one by one from the tray 142 of the document feeder 141, thereby performing a document reading operation (this operation mode will hereinafter be referred to as a “skimming-through mode”). Further, it is also possible to read a document by placing the document on a document platen glass 1401.

A printer 120 is an image forming device for forming image data received from the controller 200, on a sheet.

An image forming method according to the present exemplary embodiment is an electrophotographic method using photosensitive drums and photosensitive belts. Further, the printer 120 includes a plurality of sheet cassettes 121, 122, and 123 dealing with different sheet sizes or different sheet directions. A sheet on which printing has been performed is discharged to a sheet discharge tray 124.

<Copying Machine: Scanner Unit>

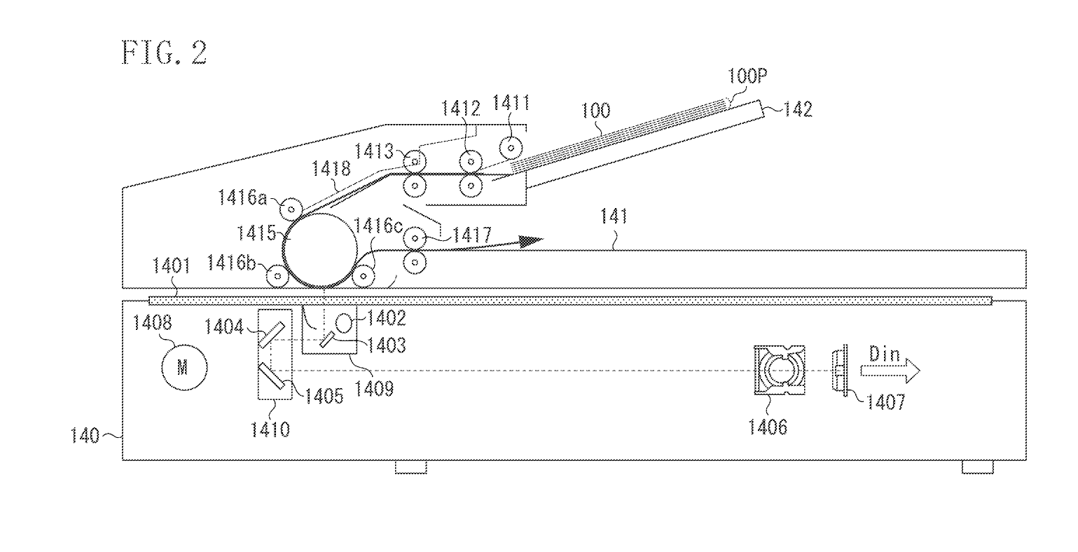

FIG. 2 is a schematic diagram illustrating the main components and the reading operation of the scanner unit 140, which uses a linear image sensor, according to the present exemplary embodiment. Particularly, FIG. 2 illustrates an overview of the main components and the reading operation in the case of “skimming through”, where the document feeder 141 is operated to read a document.

In FIG. 2, a sheaf of documents 100P to be read is placed on the tray 142. Further, in a lower portion in a document conveying direction, a feeding roller 1411, separation/conveyance rollers 1412, and registration rollers 1413 are placed. The feeding roller 1411 is rotated by a driving source (not illustrated) to send out the sheaf of documents 100P placed on the tray 142. Next, the separation/conveyance rollers 1412, which are placed downstream of the feeding roller 1411, separate and convey an uppermost document 100 conveyed from the sheaf of documents 100P. The start of rotation of the registration rollers 1413, which are placed downstream of the separation/conveyance rollers 1412, is a reference for the timing of conveying subsequent documents 100 and image reading timing.

The driving source for driving the feeding roller 1411, the separation/conveyance rollers 1412, and the registration rollers 1413 is, for example, a stepper motor.

The document 100 discharged from the registration rollers 1413 proceeds along a guide plate 1418, is nipped between a large-diameter rotating conveyance drum 1415 and driven rollers 1416a, 1416b, and 1416c, and is conveyed along the outer periphery of the conveyance drum 1415. At this time, the document 100 is conveyed once along the surface of a document platen glass 1401 at a constant speed in the direction of an arrow in FIG. 2.

An image on the document 100 is read by the image reading unit when the document 100 passes along the surface of the document platen glass 1401.

After the image has been read, the document 100 continues to be conveyed along the outer periphery of the conveyance drum 1415 and is discharged onto the document feeder 141 by sheet discharge rollers 1417.

In the skimming-through mode, it is only necessary to move a document in a certain direction. Thus, it is possible to successively read a large number of documents at high speed.

Next, the image reading unit according to the present exemplary embodiment is described. In the skimming-through mode, as described above, the document 100 passes along the surface of the document platen glass 1401. At this time, first and second mirror units 1409 and 1410 are moved by a motor 1408 and fixedly placed at positions illustrated in FIG. 2. Thus, when facing the surface of the document platen glass 1401, the document 100 is irradiated by an illumination lamp 1402 in the first mirror unit 1409, and the reflected light from the document 100 forms an image on a CCD sensor 1407 by a lens 1406 via mirrors 1403, 1404, and 1405. The reflected light input to the CCD sensor 1407 is converted into an electric signal by the CCD sensor 1407, and an electric signal of the corresponding pixel is converted into digital data by an analog-to-digital (A/D) converter (not illustrated) and input as a pixel signal Din to the controller 200.

This method uses a rod-like light source, sets a reading line parallel to the longitudinal direction of the light source, and conveys a document in a direction perpendicular to the reading line. The direction parallel to the reading line is defined as a main scanning direction, and the direction perpendicular to the reading line (the document conveying direction) is defined as a sub-scanning direction.

Further, as a method other than the above skimming-through mode, there is a method of reading an image by placing a document to be read on the document platen glass 1401. In this method, the first mirror unit 1409, which includes the mirror 1403 and the illumination lamp 1402, moves at a velocity v and under the document platen glass 1401 on which the document is placed. Further, the second mirror unit 1410, which includes the mirrors 1404 and 1405, moves at a velocity ½v in a direction similar to that of the first mirror unit 1409, thereby scanning the front side of the document 100. The first and second mirror units 1409 and 1410 are driven by the motor 1408.

<Copying Machine: Controller>

FIG. 3 is a block diagram illustrating the details of the hardware configurations of the copying machine 110 and the coin vending machine 170 used in the present exemplary embodiment, particularly, an exemplary configuration of the controller 200.

The controller 200 is connected to the scanner unit 140, which is an image input device, the printer 120, which is an image output device, a local area network (LAN) 10, and a public line (wide area network (WAN)) 12. The controller 200 performs overall control of the operation of the copying machine 110 and also controls the input and output of image information and device information.

A central processing unit (CPU) 2100 is a processor for controlling the entirety of the copying machine 110. Based on a control program stored in a read-only memory (ROM) 2120, the CPU 2100 performs overall control of access to various devices currently connected to the copying machine 110. Further, the CPU 2100 also performs overall control of various processes performed in the controller 200. A random-access memory (RAM) 2110 is a system work memory for the operation of the CPU 2100 and is also an image memory for temporarily storing image data. The ROM 2120 is a boot ROM and stores a boot program for the system. A hard disk drive (HDD) 2130 mainly stores image data and information (system software) necessary to cause a computer to start and operate. These pieces of data may be stored not only in the HDD 2130 but also in a recording medium capable of storing and holding the pieces of data even if the power is turned off.

A LAN controller (LANC) 2200 connects to the LAN 10, which inputs and outputs image data to be output and information related to device control to and from a user personal computer (PC) 20. A local interface (local IF) 2210 is an interface such as a Universal Serial Bus (USB) interface. The local IF 2210 connects to a user PC 21 and a printer using a cable 11 or connects to the coin vending machine 170 using a cable 13, and inputs and outputs data. A modem 2220 connects to the public line 12 and inputs and outputs data.

A printer IF image processing unit 2300 connects to the printer 120 and communicates with a CPU included in the printer 120. Further, the printer IF image processing unit 2300 performs synchronous-to-asynchronous or asynchronous-to-synchronous conversion on image data and image processing for print output. A scanner IF image processing unit 2400 connects to the scanner unit 140 including the document feeder 141 and communicates with a CPU included in the scanner unit 140. Further, the scanner IF image processing unit 2400 performs synchronous-to-asynchronous or asynchronous-to-synchronous conversion on image data and image processing for image reading, including a streak detection process and a blank detection process.

An image rotation unit 2500 performs a rotation process on input image data based on the process conditions set by the user through the operation unit 160 and the direction of the document.

An image compression/decompression unit 2600 performs Joint Photographic Experts Group (JPEG) compression on multivalued image data, Joint Bi-level Image Experts Group (JBIG), Modified Modified READ (MMR), or Modified Huffman (MH) compression on binary image data, and also decompressing compressed image data, where necessary.

An operation unit IF 2700 is an interface for outputting, from the controller 200 to the operation unit 160, image data to be displayed on the operation unit 160 and outputting, to the controller 200, information input by the user of the copying machine 110 through the operation unit 160.

A charging management unit 2800 is a module in charge of management for correctly charging money according to the usage of a device by the user and the printing process settings. If the user has inserted a coin into the coin vending machine 170, a coin identification unit 173 identifies the type of the coin and sends information about the coin to a charging management unit 172. The charging management unit 172 sends, based on information about the amount of inserted money and the charging used by the copying machine 110, information about the amount of money currently inserted to a local IF 171 of the coin vending machine 170. The local IF 171 communicates amount-of-money information (A) of the money currently inserted to the local IF 2210 of the copying machine 110, and the local IF 2210 communicates charging information (B) of the charging used by the copying machine 110 to the local IF 171. In the copying machine 110, the local IF 2210 is connected to the charging management unit 2800 of the copying machine 110. The charging management unit 2800 counts the money charged for a copy operation set through the operation unit 160 of the copying machine 110, compares the charged money with the amount of money currently inserted, and performs control to determine whether or not it is possible to output a copy. Further, when a sheet is discharged to output a copy, the charging management unit 2800 sends information about the charging to the coin vending machine 170.

<Copying Machine: Operation Unit>

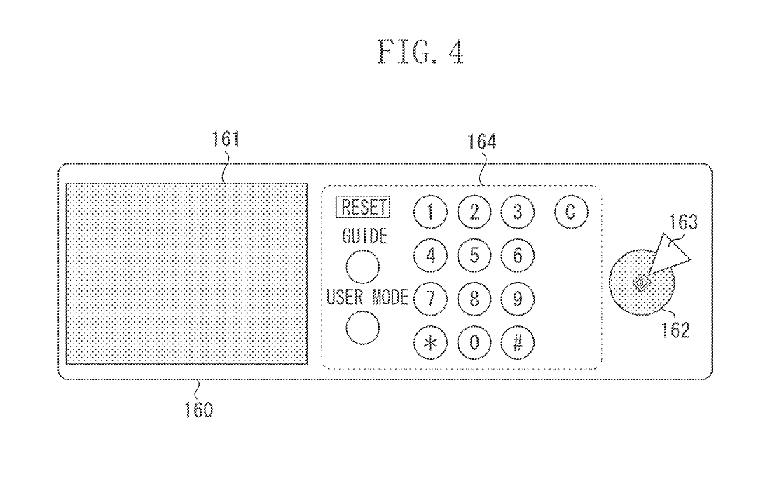

FIG. 4 is a diagram illustrating an exemplary configuration of the operation unit 160.

A liquid crystal operation panel (display unit) 161 is obtained by combining liquid crystals with a touch panel. The liquid crystal operation panel 161 displays an operation screen, and if a display key has been pressed by the user, sends information about the pressing of the display key to the controller 200 to control display. A start key 162 is used to start the operation of reading and printing a document image, or give instructions to start other functions. In the start key 162, light-emitting diodes (LEDs) of two colors such as green and red are incorporated so that if the green LED lights up, it indicates that it is possible to start an operation, and if the red LED lights up, it indicates that it is not possible to start an operation. A stop key 163 functions to stop an operation that is being performed. A hardware key group 164 includes a numeric keypad, a clear key, a reset key, a guide key, and a user mode key.

<Scanner IF Image Processing Unit>

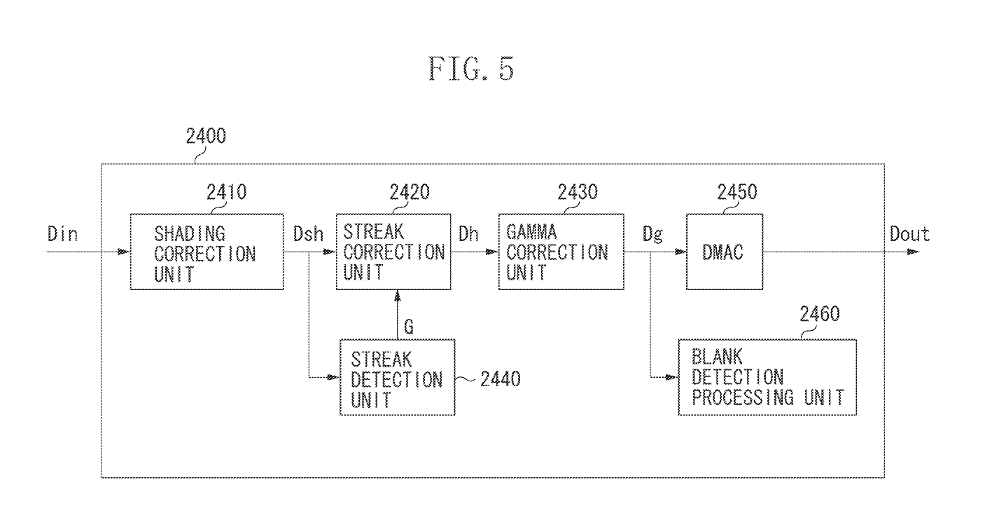

FIG. 5 is a block diagram illustrating an exemplary configuration of the scanner IF image processing unit 2400.

As described above, in the skimming-through mode illustrated in FIG. 2, a document reading position is a fixed position in an optical system. Attached and fixed dirt, floating dirt, dust, scratches, and stains that exist in the document reading position cause the occurrence of a streak. The following description is given taking as an example the case where dirt causes the occurrence of a streak. Even if, however, anything other than dirt causes the occurrence of a streak, the present exemplary embodiment is applicable.

To a shading correction unit 2410, the pixel signal Din (see FIG. 2) output from the scanner unit 140 is input. The shading correction unit 2410 performs a correction process on luminance unevenness caused by the characteristics of the optical system and an imaging system, using a known technique, to obtain an image having a uniform brightness. A pixel signal Dsh, which has been subjected to the shading correction process, is output to the subsequent stage.

If dirt that causes the occurrence of a streak has become attached to the document reading position, a streak correction unit 2420 acquires position information G of the streak from a streak detection unit 2440 and performs a correction process for making less conspicuous the streak that occurs in a read image due to the dirt. Specifically, the streak correction unit 2420 performs the correction process on the streak using normal pixels around the streak, thereby reducing the influence of the dirt. Hereinafter, a pixel represented by a pixel signal and included in a streak will be referred to as an “abnormal pixel”. The details of the correction method of the streak correction process will be described later. A pixel signal Dh, which has been subjected to the streak correction process, is output to the subsequent stage.

A gamma correction unit 2430 corrects the difference between the color characteristics of a reading element and a device, by using a known technique. A pixel signal Dg, which has been subjected to this gamma correction process, is output to the subsequent stage.

A direct memory access controller (DMAC) 2450 is a DMA controller that functions to write the pixel signal Dg output from the gamma correction unit 2430 as data Dout directly, not via the CPU 2100, to an area designated in the image memory (the RAM 2110).

If fixed dirt or floating dirt that causes the occurrence of a streak has become attached to the document reading position, the streak detection unit 2440 detects the position of the streak generated under the influence of the attached dirt. The position information G of the detected streak is sent to the streak correction unit 2420, and if an image having a streak has actually been input, is used to identify a correction range (a streak portion).

<Blank Detection Processing Unit>

The term “blank” as used here refers to a document having no print information (i.e., no content). When there is no print information, a colored document, such as colored paper or recycled paper is also treated as a blank. That is, blank detection is the determination of the presence or absence of a content printed on a document. Further, image data obtained by reading such a document or image data having only show-through obtained by reading a document is also referred to as a blank. On the other hand, a document having a few written characters or thin written characters printed using halftone dots is not a blank.

Image data obtained by reading a sheet having handwritten print information or information printed by a printer is referred to as “content data”.

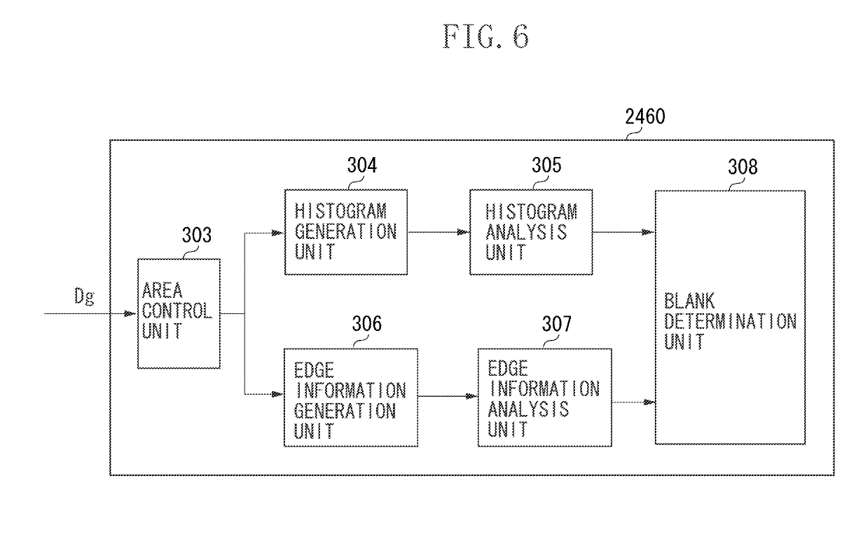

FIG. 6 is a diagram illustrating the internal configuration of a blank detection processing unit 2460 according to the present exemplary embodiment. The blank detection processing unit 2460 is connected to a register (not illustrated) and holds control parameters and process results. The CPU 2100 and the blank detection processing unit 2460 write the control parameters and the process results to the register, and the blank detection processing unit 2460 operates by reading the control parameters set in the register.

The blank detection processing unit 2460 holds a determination result whether or not a read document is ultimately a blank. Particularly, in the present exemplary embodiment, the blank detection processing unit 2460 holds a plurality of results of this determination. That is, the blank detection processing unit 2460 can have control parameters at a plurality of levels and hold blank determination results at a plurality of levels. The details, such as what control parameters the blank detection processing unit 2460 has at a plurality of levels, will be described later.

In the present exemplary embodiment, to the blank detection processing unit 2460, the pixel signal Dg output from the gamma correction unit 2430 is input.

An area control unit 303 controls areas for generating histograms and edge information, from input image data. When a document is read using the document feeder 141, the front end, the rear end, the left end, and the right end of the document depend on the configuration of the conveyance of the document and the configuration of the light source of the CCD sensor 1407.

The area control unit 303 determines whether or not the pixel position, in a document, of a currently input pixel is a valid area or an invalid area. Then, the area control unit 303 generates a signal indicating a valid area or an invalid area.

A front end portion, a rear end portion, a left end portion, and a right end portion, that is, peripheral edge portions, of image data read by the document feeder 141 include data of a shadow that occurs under the influence of the light source.

In the generation of histograms and the generation of edge information, the use of a value other than that of document image data hinders accurate analysis. Thus, it is necessary to perform control so as not to include information about this shadow portion.

The area control unit 303 identifies such a shadow portion and outputs a signal indicating that the shadow portion is an invalid area and a portion other than the shadow portion is a valid area so that histograms and edge information are not generated for the shadow portion in the processing at the subsequent stage.

For example, when an A4-size document is read, an area having a width of about 2 mm in the front end portion, the rear end portion, the left end portion, and the right end portion includes data of a shadow. Thus, this area is determined as an invalid area.

Further, it is also possible to perform control to adjust the width of an invalid area so that an area including punched holes is an invalid area.

The term “valid area” refers to an area other than an invalid area in image data and refers to an area to be processed.

Further, the area control unit 303 divides a main scanning valid area and a sub-scanning valid area of the document into a plurality of areas. That is, the area control unit 303 outputs a valid/invalid area signal 509 and an area signal 510, in addition to the pixel signal Dg, to processing units at the subsequent stage (a histogram generation unit 304 and an edge information generation unit 306).

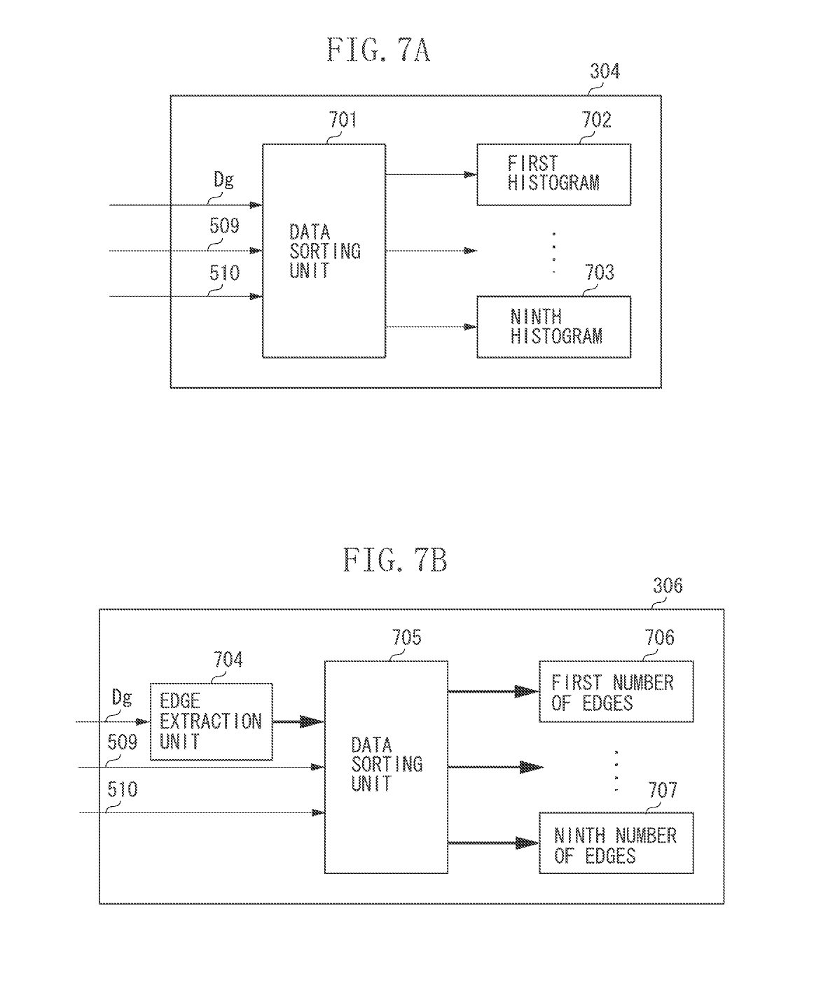

FIGS. 7A and 7B illustrate the internal configurations of the histogram generation unit 304 and the edge information generation unit 306.

FIG. 7A illustrates the internal configuration of the histogram generation unit 304.

A data sorting unit 701 is a unit for reflecting the frequency of pixel values on a histogram of each divided area at the subsequent stage, according to image data 301, the valid/invalid area signal 509, and the area signal 510. In each histogram, the frequency corresponding to pixel values of sorted image data is added. Since the image data 301 needs to be synchronous with the valid/invalid area signal 509 and the area signal 510, the image data 301 is also delayed according to the delay of a signal in the area control unit 303. This, however, is not described here. If the valid/invalid area signal 509 indicates an invalid area, the data sorting unit 701 does not provide an output to the subsequent stage. Further, if the histogram generation unit 304 generates histograms with 32 gray scales (5 bits) for the bit accuracy (e.g., 8 bits) of the pixel signal Dg, the data sorting unit 701 also has the function of outputting 5 bits obtained by removing the lower 3 bits to the subsequent stage. That is, the data sorting unit 701 has the function of quantizing input image data and reflecting the quantized image data on a frequency distribution. FIG. 7A illustrates only a first histogram 702 and a ninth histogram 703 and does not illustrate second to eighth histograms for ease of description. FIG. 7B illustrates the internal configuration of the edge information generation unit 306.

An edge extraction unit 704 extracts edges from the image data 301. The edge extraction unit 704 performs a convolution operation using, for example, a 7-by-7 matrix and outputs to the subsequent stage an edge signal indicating an edge portion if the output is equal to or greater than a threshold, or indicating a non-edge portion if the output is less than the threshold. The coefficients of the 7-by-7 matrix and the threshold used here are read from a register (not illustrated). A data sorting unit 705 reflects the edge signal output from the edge extraction unit 704, the valid/invalid area signal 509, and the area signal 510 on the numbers of edges at the subsequent stage. That is, if the edge signal indicates an edge portion, the data sorting unit 705 outputs a signal to the number of edges of a divided area specified by the valid/invalid area signal 509 and the area signal 510 and adds, for example, 1 to the number of edges of the corresponding divided area. At this time, if the valid/invalid area signal 509 indicates an invalid area, the data sorting unit 705 does not provide an output to the subsequent stage. FIG. 7B illustrates only the first number of edges 706 and the ninth number of edges 707 and does not illustrate second to eighth numbers of edges for ease of description.

To obtain blank determination results at a plurality of levels, a plurality of threshold parameters is provided for use in the edge extraction unit 704. Consequently, the first number of edges 706 and the ninth number of edges 707 hold the numbers of edges based on the respective threshold parameters.

The description returns to the blank detection processing unit 2460 in FIG. 6.

A histogram analysis unit 305 determines, based on the first to ninth histograms generated by the histogram generation unit 304, whether or not the document is a blank.

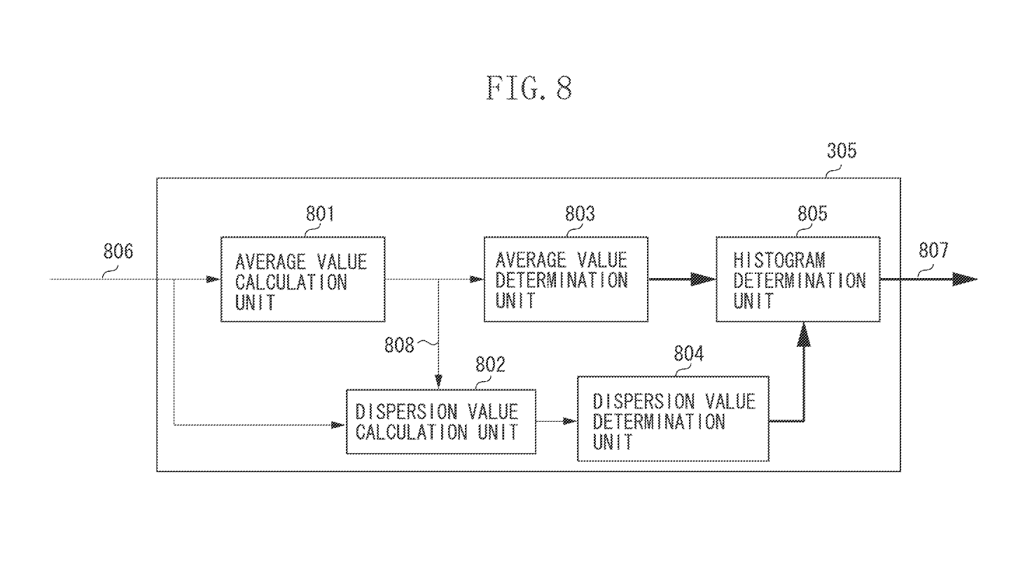

FIG. 8 illustrates the internal configuration of the histogram analysis unit 305.

An average value calculation unit 801 calculates first to ninth average values 808 from first to ninth histograms 806, respectively. The first to ninth histograms 806 are generated by the histogram generation unit 304. The histograms 806 include, for example, a value indicating an area, a value indicating a luminance value, and a value indicating the frequency of each luminance.

Further, the luminance can be acquired by extracting only a G signal from RGB data of read image data. The method of acquiring the luminance is not limited to this, and another method may be used so long as the luminance is acquired.

The first to ninth average values 808 are the average values of the pixel values in the respective divided areas. A dispersion value calculation unit 802 calculates the dispersion of the pixel values in each of the first to ninth divided areas from the first to ninth histograms 806 generated by the histogram generation unit 304 and the first to ninth average values 808 calculated by the average value calculation unit 801.

At this time, a difference value is calculated by (average value−luminance value)×(average value luminance value)×frequency. Then, a dispersion value is calculated by cumulatively adding the difference values for all the luminance values and further performing the process of dividing the cumulative addition values by all the frequencies. For example, if there is any printed matter, the calculated dispersion value is high. If there is only a background color, the calculated dispersion value is low.

An average value determination unit 803 compares each average value calculated by the average value calculation unit 801 with a threshold, thereby determining whether or not the corresponding divided area is covered by thickly printed matter (e.g., a dark portion of a photograph). The average value determination unit 803 outputs a determination signal indicating a blank if the average value is equal to or greater than the threshold, or indicating a content (not a blank) if the average value is less than the threshold. The average value determination unit 803 makes this determination for each of the first to ninth areas.

A dispersion value determination unit 804 compares each dispersion value calculated by the dispersion value calculation unit 802 with a threshold, thereby determining the variation in the luminance value of the corresponding divided area. At this time, if the dispersion value is equal to or greater than the threshold, the variation in the luminance is large. Thus, the dispersion value determination unit 804 determines that printed matter is present, and then outputs a determination signal indicating content. If the dispersion value is less than the threshold, the variation in the luminance is small. Thus, the dispersion value determination unit 804 determines that only a background color is present, and then outputs a determination signal indicating a blank.

The dispersion value determination unit 804 makes this determination for each of the first to ninth areas.

A histogram determination unit 805 determines, based on the determination signals of the average value determination unit 803 and the determination signals of the dispersion value determination unit 804, whether or not a document image 203 is a blank. At this time, if all the determination signals of the average value determination unit 803 and all the determination signals of the dispersion value determination unit 804 in the first to ninth areas indicate a blank candidate, the histogram determination unit 805 outputs a blank candidate signal. If there is a signal indicating content in at least one of the areas, the histogram determination unit 805 outputs a determination signal 807 indicating content, that is, not a blank.

In this case, if there is a signal indicating content in at least one of the areas, the areas are determined as content. Alternatively, for example, a threshold process may be performed on the number of areas determined as content. If a predetermined number of areas or more have been determined as content, the histogram determination unit 805 may output a determination signal indicating a content.

To obtain blank determination results at a plurality of levels, a plurality of threshold parameters is provided for use in the average value determination unit 803, and a plurality of threshold parameters is provided for use in the dispersion value determination unit 804. Consequently, the determination signal 807 output from the histogram determination unit 805 includes a plurality of determination results based on a plurality of levels (a plurality of parameters).

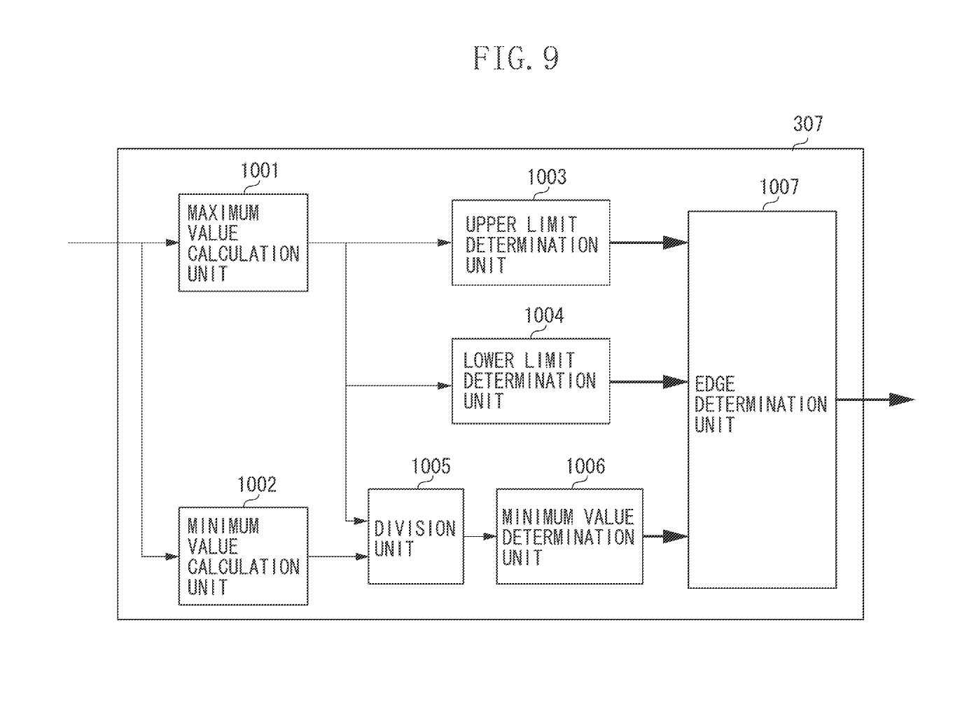

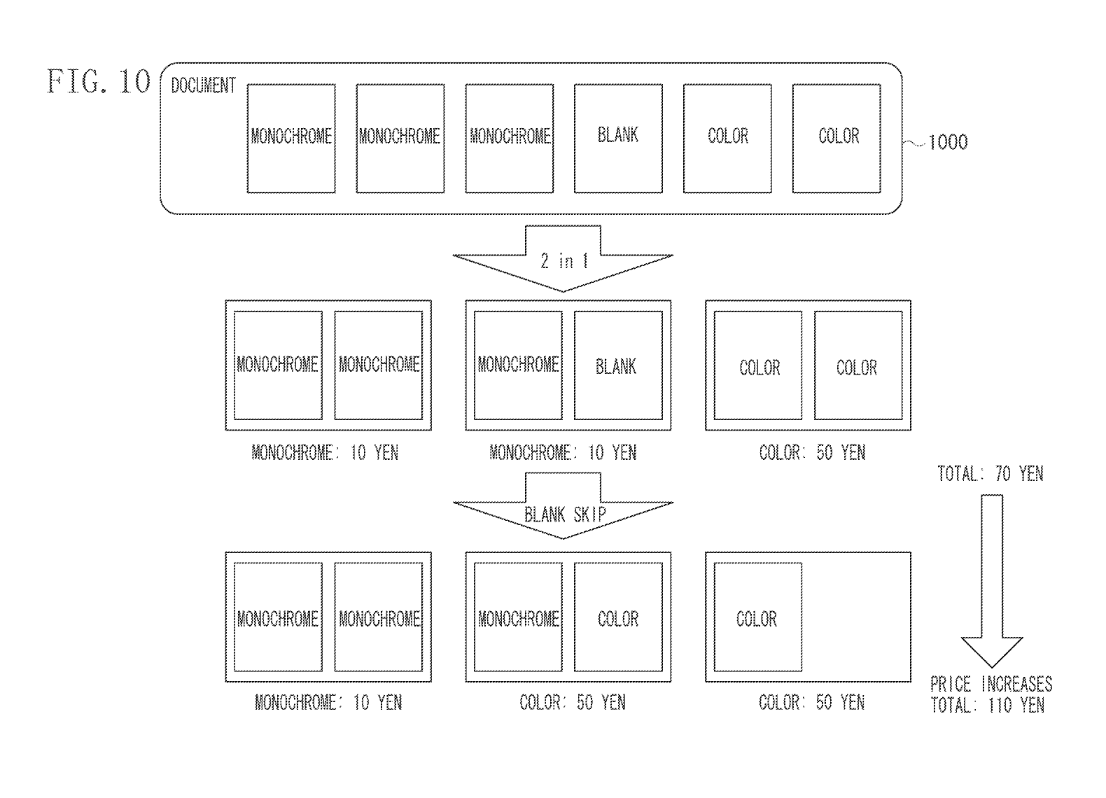

FIG. 9 illustrates the internal configuration of an edge information analysis unit 307.

A maximum value calculation unit 1001 obtains the maximum number of edges from the first to ninth numbers of edges generated by the edge information generation unit 306.

A minimum value calculation unit 1002 obtains the minimum number of edges from the first to ninth numbers of edges generated by the edge information generation unit 306.

An upper limit determination unit 1003 performs a threshold process on the maximum number of edges obtained by the maximum value calculation unit 1001 and outputs a determination signal indicating whether the document is a blank or not. At this time, the upper limit determination unit 1003 outputs a determination signal indicating a content if the number of edges is equal to or greater than a threshold, or a signal indicating a blank candidate if the number of edges is less than the threshold. For example, in the case of a digital multifunction peripheral, security dots may be printed to restrict the copying of printed matter. These security dots may be printed on the entire document, and therefore, when the edge distributions of the respective areas are compared at the subsequent stage, the same numbers of edges may be counted in all the areas. Consequently, the areas may be determined as a blank. That is, if the number of edges exceeds a predetermined number of edges, it is necessary to determine the areas as content. In this process, the threshold for the number of edges is set to about 150,000, for example.

A lower limit determination unit 1004 performs a threshold process on the maximum number of edges obtained by the maximum value calculation unit 1001 and outputs a determination signal indicating whether the document is a blank or not. At this time, the lower limit determination unit 1004 outputs a determination signal indicating a content candidate if the number of edges is equal to or greater than a threshold, or a signal indicating a blank if the number of edges is less than the threshold.

For example, in the case of good-quality paper such as coated paper, edges may be hardly extracted. That is, when the number of edges is 10 in an area and the number of edges is 0 in another area, if the numbers of edges are compared using the relative values between the areas, 0/10=0. Thus, the correlation value may be minimum, and the areas may be determined as content. The state where the correlation value is low, refers to the state where the difference between the numbers of edges of areas is great.

For example, in the case of general white paper, if the maximum number of edges is 320 and the minimum number of edges is 300, 300/320=0.93. Thus, the correlation value is high. That is, if the number of edges is below a predetermined number of edges in each area, it is necessary to determine the areas as a blank. In this process, the threshold for the number of edges is set to about 400, for example. This is the number of edges to be extracted when a general white sheet is used.

A division unit 1005 performs a division process on the maximum number of edges calculated by the maximum value calculation unit 1001 and the minimum number of edges calculated by the minimum value calculation unit 1002, thereby calculating the correlation value between the areas.

In this case, the division unit 1005 calculates the correlation value by dividing the minimum number of edges by the maximum number of edges.

A minimum value determination unit 1006 outputs, based on the correlation value calculated by the division unit 1005, a determination signal indicating whether the document is a blank. At this time, the minimum value determination unit 1006 compares the correlation value calculated by the division unit 1005 with a threshold. The minimum value determination unit 1006 determines the areas as a blank if the correlation value is equal to or greater than the threshold, or determines the areas as content if the correlation value is less than the threshold. That is, if the correlation value is high, the difference between the maximum number of edges and the minimum number of edges is small. Thus, the minimum value determination unit 1006 determines the areas as a blank. If the correlation value is low, the difference between the maximum number of edges and the minimum number of edges is great. Thus, the minimum value determination unit 1006 determines the areas as content.

An edge determination unit 1007 determines, based on the determination signals of the upper limit determination unit 1003, the lower limit determination unit 1004, and the minimum value determination unit 1006, whether or not the document is a blank.

In this case, if the determination signal of the upper limit determination unit 1003 indicates a content, the edge determination unit 1007 outputs the determination signal indicating that the document is a content, without reference to the determination signals of the lower limit determination unit 1004 and the minimum value determination unit 1006.

Further, if the determination signal of the upper limit determination unit 1003 indicates that the document is a blank candidate and the determination signal of the lower limit determination unit 1004 indicates that the document is a blank, the edge determination unit 1007 outputs the determination signal indicating that the document is a blank, without reference to the determination signal of the minimum value determination unit 1006. Further, if the determination signal of the upper limit determination unit 1003 indicates that the document is a blank candidate and the determination signal of the lower limit determination unit 1004 indicates that the document is a content candidate, the edge determination unit 1007 outputs the determination signal of the minimum value determination unit 1006.

To obtain blank determination results at a plurality of levels, a plurality of threshold parameters is provided for use in the upper limit determination unit 1003. Consequently, the edge determination unit 1007 outputs a plurality of edge determination results based on the respective threshold parameters.

The description returns to the blank detection processing unit 2460 in FIG. 6.

A blank determination unit 308 is a unit for determining, based on the determination signals of the histogram analysis unit 305 and the edge information analysis unit 307, whether or not the document is ultimately a blank.

In this case, if the determination signal of the histogram analysis unit 305 indicates that the document is a blank and the determination signal of the edge information analysis unit 307 indicates that the document is a blank, the blank determination unit 308 calculates a determination signal indicating that the read document image is a blank. If at least either one of the determination signals of the histogram analysis unit 305 and the edge information analysis unit 307 indicates that the document is content, the blank determination unit 308 outputs a determination signal indicating that the document is content. Further, the blank determination unit 308 notifies the CPU 2100 that the blank detection process has ended.

To obtain blank determination results at a plurality of levels, the blank determination unit 308 calculates determination results at a plurality of levels with reference to the results based on the plurality of threshold parameters used in the histogram analysis unit 305 and the edge information analysis unit 307. That is, the blank determination unit 308 calculates and holds a plurality of determination results whether or not the document is ultimately a blank.

As a suitable exemplary embodiment, a plurality of threshold parameters is provided in each unit (704, 803, 804, and 1003). Alternatively, regardless of this, a plurality of threshold parameters may be provided in other processing units, and a plurality of various control parameters is provided, thereby ultimately calculating and holding a plurality of determination results.

Further, if an attempt is made to exhaustively calculate the results based on the respective threshold parameters, the calculated results involve an excessive operational load due to “the number of threshold parameters * the number of types of threshold parameters”. To avoid this, a plurality of levels (for example, five steps) is provided for threshold parameters to set the threshold parameters at each level. Consequently, various mathematical operations are narrowed down to the combinations of the parameters at each level (e.g., five patterns and five determination results). This reduces the operational load.

While the blank detection has been described in the above, the present invention is not limited to this. The blank detection method used in the present exemplary embodiment only needs to be a method capable of determining whether or not image data obtained by reading a document is a blank having no print information.

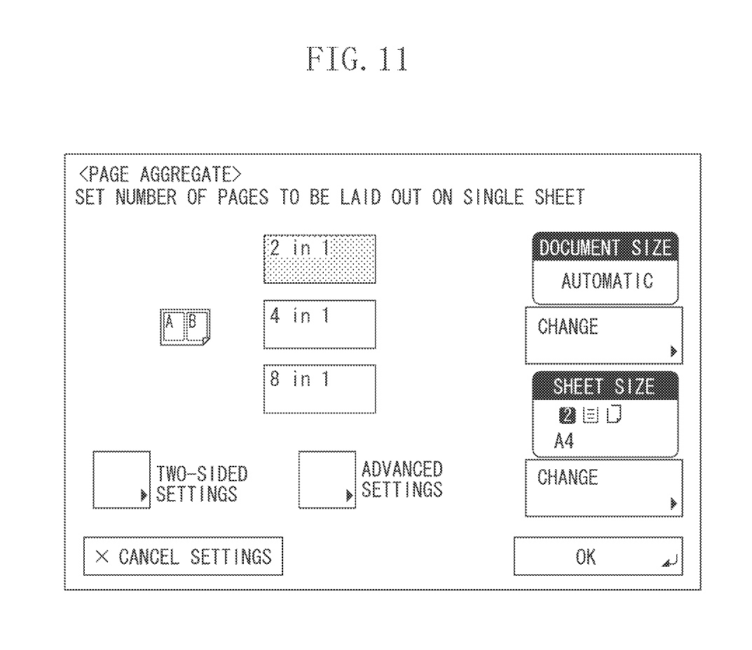

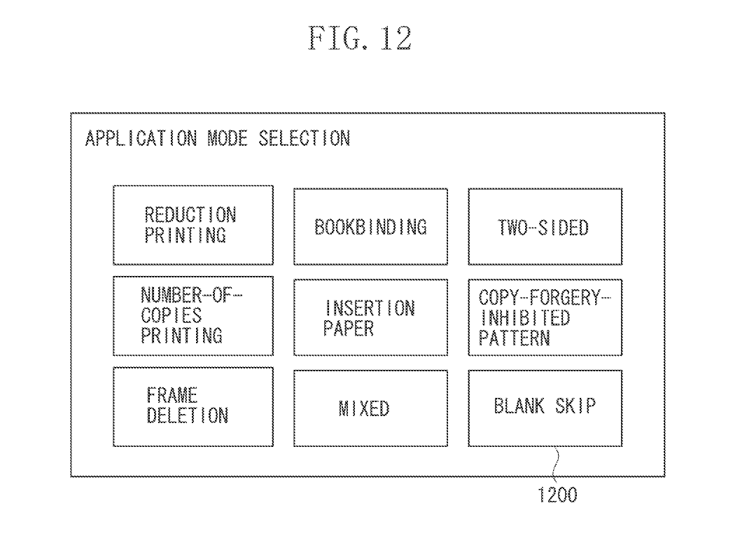

Next, with reference to FIGS. 11 to 15, a description is given of the flow in the case where a page aggregate function and a blank skip function operate in combination when charged copying is performed.

First, a setting screen for each mode is described.

FIG. 11 is a diagram illustrating an example of a page aggregate setting screen. If a page aggregate setting has been made, N-in-1 printing is performed, in which a layout is set, and pieces of image data obtained from any two or more documents are laid out on a single sheet and printed. The number of pages to be laid out on a single sheet has three options, namely 2, 4, and 8, for example. If a page aggregate setting has been made, acquired documents are subjected to a reduction or enlargement process based on the relationship between the document size of the acquired documents and the sheet size to be used in printing, and the documents are printed on a sheet.

Further, the page aggregate setting screen allows the user to set two-sided printing, in which pieces of data are laid out on both sides of a single sheet.

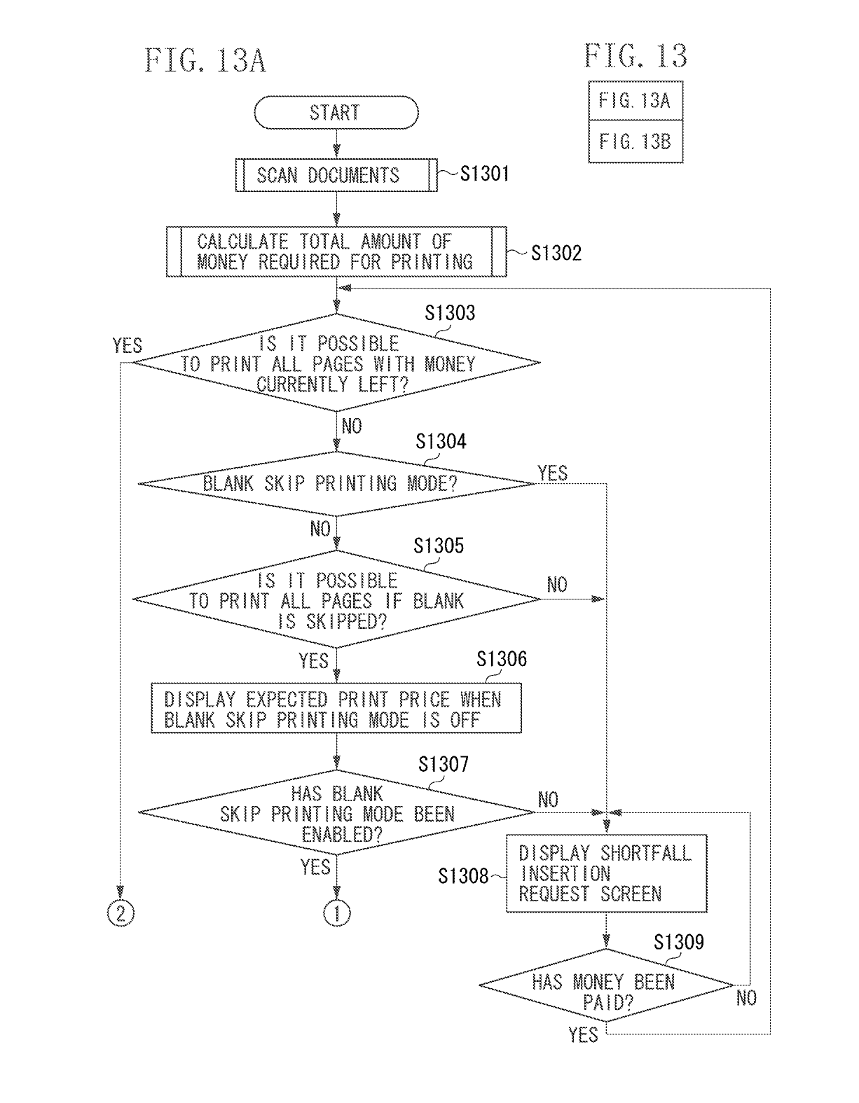

FIG. 12 is a diagram illustrating an example of a various application mode setting screen. The selection of a blank skip printing mode 1200 enables a blank skip printing mode.

If the blank skip printing mode has been enabled, a printing process is not performed on image data determined as having no print information. That is, if blank skip printing has been performed on pieces of image data having print information on the first page, having no print information on the second page, and having print information on the third page, the image data on the third page is laid out at the position where the image data on the second page would be laid out.

That is, the printing process proceeds by skipping the image data on the second page. For example, if 2-in-1 printing has been set in the aggregate setting, the pieces of image data on the first page and the third page are aggregated on a single sheet.

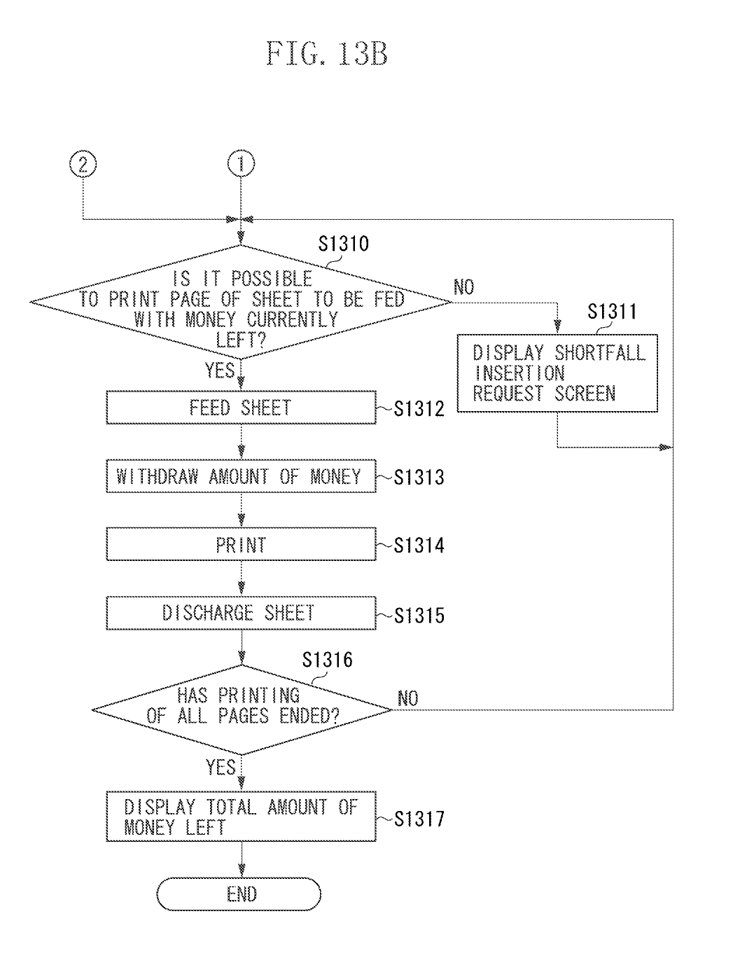

Next, a charged-copying operation is described. FIG. 13 is a flow chart illustrating the flow for charged copying after the user has made desired settings and pressed the start key 162. Programs according to the processes illustrated in the flow chart are controlled by the CPU 2100 of the controller unit 200. The CPU 2100 sequentially loads programs stored in the ROM 2120 or the hard disk 2130 into the RAM 2110 and execute the programs.

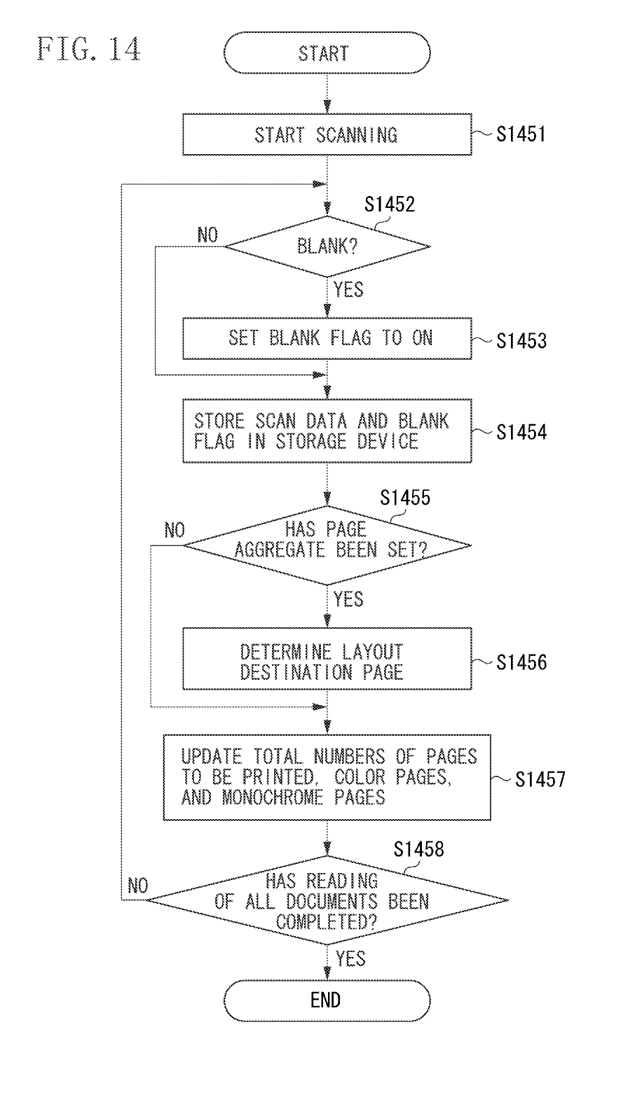

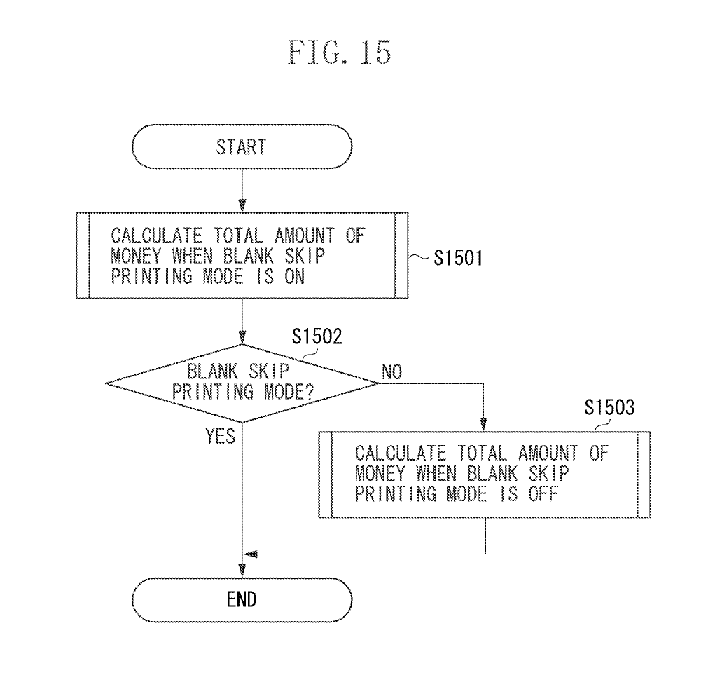

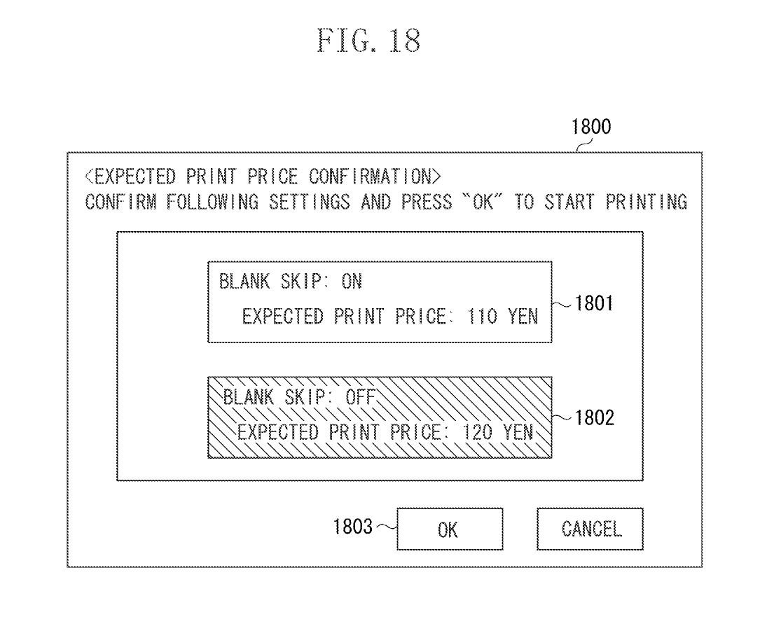

First, in subroutine S1301, the CPU 2100 scans documents. The detailed flow of subroutine S1301 will be described with reference to FIG. 14. After the scanning of all the documents has ended, then in subroutine S1302, the CPU 2100 calculates the total amount of money required for printing. The detailed flow of subroutine S1302 will be described with reference to FIG. 15. In step S1303, the CPU 2100 determines whether or not it is possible to print all the pages with the money currently left. If the amount of already paid money is insufficient (NO in step S1303), then in step S1304, the CPU 2100 checks whether or not the blank skip printing mode 1200 has been selected. If the blank skip printing mode 1200 has been selected (YES in step S1304), the processing proceeds to step S1308. If the blank skip printing mode 1200 has not been selected (NO in step S1304), the processing proceeds to step S1305. In step S1305, the CPU 2100 determines whether or not it is possible to print all the pages with the amount of currently paid money if blank skip printing is performed. If it is not possible to print all the pages (NO in step S1305), the processing proceeds to step S1308. If it is possible to print all the pages when blank skip printing is performed (YES in step S1305), then in step S1306, the CPU 2100 causes the operation unit 160 to display expected print prices in a case where the blank skip printing mode is on and in a case where the blank skip printing mode is off. At this time, for example, as shown in a screen 1800 in FIG. 18, the CPU 2100 causes the operation unit 160 to display the expected print prices with a blank-skip-off setting button 1802 selected. On the screen 1800 in FIG. 18, the blank-skip-off setting button 1802 is highlighted to indicate that the blank skip printing mode is not being selected. When the expected print prices have been displayed in step S1306, the user presses a blank-skip-on setting button 1801 and then presses an OK button 1803, thereby enabling the blank skip printing mode. In step S1307, the CPU 2100 determines whether or not the blank skip printing mode has been enabled. If the blank skip printing mode has been enabled (YES in step S1307), the processing proceeds to step S1310. If the OK button 1803 has been pressed with the blank-skip-off setting button 1802 remaining selected (NO in step S1307), then in step S1308, the CPU 2100 causes the operation unit 160 to display an insertion request screen for shortfall money. The CPU 2100 repeats the process of step S1308 until it is determined in step S1309 that money has been paid. If it has been determined in step S1309 that money has been paid (YES in step S1309), the processing returns to step S1303. If it is possible to print all the pages with the money currently left in step S1303 (YES in step S1303), then in step S1310, the CPU 2100 determines whether or not it is possible to print the pages of sheets to be fed with the money currently left. If the amount of money paid is insufficient (NO in step S1310), then in step S1311, the CPU 2100 causes the operation unit 160 to display the insertion request screen for shortfall money until the insufficiency of the amount of money is overcome. If it is possible to print the pages of sheets to be fed with the money currently left (YES in step S1310), then in step S1312, the CPU 2100 feeds the sheets. In step S1313, the CPU 2100 withdraws the amount of money for the pages of the fed sheets. In step S1314, the CPU 2100 performs printing. In step S1315, the CPU 2100 discharges the sheets. In step S1316, the CPU 2100 determines whether or not the printing of all the pages has ended. If the printing of all the pages has not ended (NO in step S1316), the CPU 2100 repeats the processes of steps S1310 to S1315. If the printing of all the pages has ended (YES in step S1316), the processing proceeds to step S1317. In step S1317, the CPU 2100 causes the operation unit 160 to display the money left, and the flow ends.

FIG. 14 is a flow chart illustrating the flow of a document scanning process. Programs according to the processes illustrated in the flow chart are controlled by the CPU 2100 of the controller unit 200, which sequentially loads programs stored in the ROM 2120 or the hard disk 2130 into the RAM 2110 and executes the programs.

First, in step S1451, the CPU 2100 starts scanning. In step S1452, the CPU 2100 determines, using image data (scan data) obtained by scanning a document, whether or not the scanned image is a blank. The determination of a blank is made by the blank determination unit 308. If it has been determined that the scanned document is a blank (YES in step S1452), the processing proceeds to step S1453. In step S1453, the CPU 2100 sets a blank flag of the scan data corresponding to the document, to be on. In step S1454, the CPU 2100 saves the scan data and the blank flag set in S1453, in the storage device 2130. Then, in step S1455, the CPU 2100 determines whether or not page aggregate has been set. If it has been determined that page aggregate has been set (YES in step S1455), then in step S1456, the CPU 2100 determines a layout destination page. If it has been determined in step S1455 that page aggregate has not been set (NO in step S1455), or if the process of step S1456 has ended, then in step S1457, the CPU 2100 updates the total number of pages to be printed, the total number of color pages, and the total number of monochrome pages at the current moment. In step S1458, the CPU 2100 determines whether or not the reading of all the documents has been completed. If the reading of all the documents has not been completed (NO in step S1458), the CPU 2100 repeatedly performs the processes of steps S1452 to S1457.

FIG. 15 is a flow chart illustrating the flow of the process of calculating the total amount of money required to print the already scanned documents in the print settings desired by the user. Programs according to the processes illustrated in the flow chart are controlled by the CPU 2100 of the controller unit 200, which sequentially loads programs stored in the ROM 2120 or the hard disk 2130 into the RAM 2110 and executes the programs.

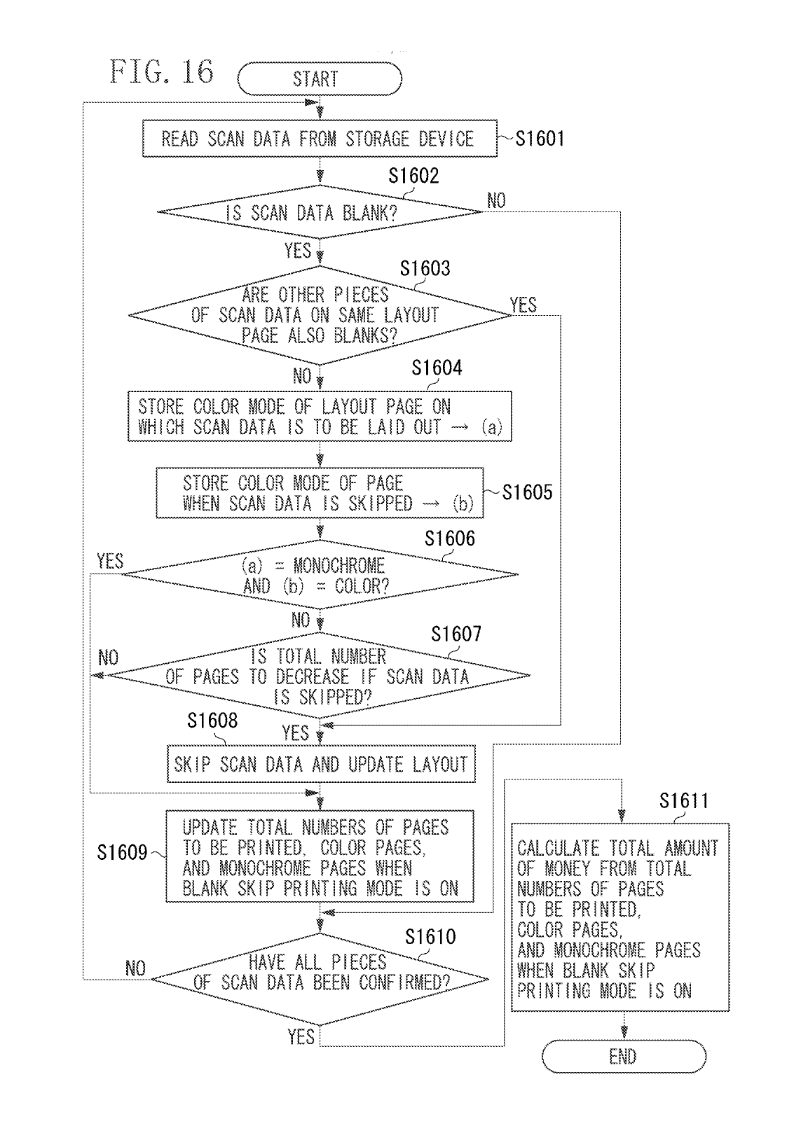

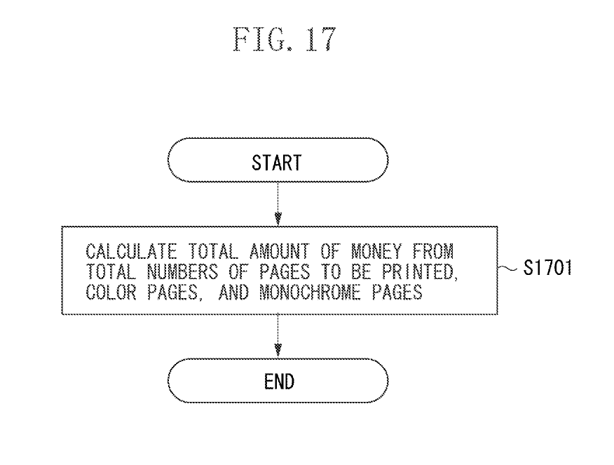

In subroutine S1501, the CPU 2100 calculates the total amount of money required when the blank skip printing mode is enabled. The detailed flow of subroutine S1501 will be described with reference to FIG. 16. In step S1502, the CPU 2100 checks whether or not the blank skip printing mode 1200 has been selected. If the blank skip printing mode 1200 has been selected (YES in step S1502), the flow ends. If the blank skip printing mode 1200 has not been selected (NO in step S1502), then in subroutine S1503, the CPU 2100 calculates the total amount of money required when the blank skip printing mode is disabled. The detailed flow of subroutine S1503 will be described with reference to FIG. 17.

FIG. 16 is a flow chart illustrating the flow for calculating the total amount of money required when the blank skip printing mode is enabled. Programs according to the processes illustrated in the flow chart are controlled by the CPU 2100 of the controller unit 200, which sequentially loads programs stored in the ROM 2120 or the hard disk 2130 into the RAM 2110 and executes the programs.

A description is given below of the process of calculating the total amount of the fee required when the blank skip printing mode is enabled in the case where pieces of scan data obtained by reading a plurality of documents are printed. Among the pieces of scan data obtained by reading a plurality of documents, the scan data of the document on the first page is referred to as “first scan data”.

First, in step S1601, the CPU 2100 reads the first scan data from the storage device 2130. In step S1602, the CPU 2100 checks whether or not the blank flag of the first scan data read in step S1601 is set to be on. The blank flag is saved in the storage device 2130 in step S1453. If, as a result of step S1602, it has been determined that the first scan data is not a blank (NO in step S1602), the processing proceeds to step S1610. In step S1610, the CPU 2100 performs the process of checking whether or not all the pieces of scan data have been confirmed. If, as a result of step S1602, it has been determined that the first scan data is a blank (YES in step S1602), then in step S1603, the CPU 2100 determines whether or not the other pieces of scan data laid out on the same layout page (the page to be output to the same sheet) as the current scan data are also blanks.

For example, if 2-in-1 printing has been set in the page aggregate setting on the setting screen illustrated in FIG. 11, the current first scan data is the first page of the document. Thus, the CPU 2100 determines whether or not the scan data (second scan data) obtained by reading the next page is a blank. Then, if it has been determined that all the other pieces of scan data are also blanks (YES in step S1603), the processing proceeds to step S1608.

Further, similarly, if two-sided printing has been set in the page aggregate setting, the CPU 2100 determines whether or not the scan data of the next page to be printed on the layout page same as the current first scan data is a blank, that is, the back side of the sheet on which the first scan data is to be printed, is a blank.

If it has been determined in step S1603 that at least one of the pieces of scan data laid out on the same layout page is not a blank (NO in step S1603), then in step S1604, the CPU 2100 stores the color mode of the layout page on which the current scan data is laid out. The color mode stored in step S1604 is defined as a color mode (a).

In step S1605, the CPU 2100 stores the color mode of the layout page when the first scan data determined as a blank in step S1602 is skipped.

That is, the CPU 2100 stores the color mode of the layout page when among the pieces of scan data laid out on the next layout page, the scan data having the first page number is laid out on the current layout page. Specifically, in the case of a 2-in-1 setting, the first scan data is not laid out on the current layout page, but the scan data (third scan data) two pages after the first scan data is laid out on the current layout page.

The color mode stored in step S1605 is defined as a color mode (b). In step S1606, the CPU 2100 determines whether or not the color mode (a) stored in step S1604 is monochrome, and the color mode (b) stored in step S1605 is color. If the determination in step S1606 is affirmative, the skipping of the scan data increases the amount of money required to perform charged copying because the color mode changes from monochrome to color.

For example, in the case of the above example, if the first scan data is monochrome and the third scan data is color, the skipping of the blank increases the fee for the charged copying.

That is, in S1606, the CPU 2100 compares the charged price in the case of employing a layout (a first layout) without skipping the blank, with the charged price in the case of employing a layout (a second layout) obtained by skipping the blank. If the charged price in the case of employing the second layout is higher (YES in step S1606), the processing proceeds to S1609.

Thus, the scan data determined as a blank is not skipped, and the processing proceeds to step S1609.

If the determination in step S1606 is negative, that is, if the color modes (a) and (b) are the same, or if the color mode changes from color to monochrome (if the charged price in the case of employing the second layout is lower) (NO in step S1606), the processing proceeds to step S1607. Then, in step S1607, the CPU 2100 determines whether or not the total number of pages to be printed is to decrease if the scan data determined as a blank is skipped and the layout of the page aggregate is changed.

If the total number of pages is not to decrease (NO in step S1607), the processing proceeds to step S1609. If the total number of pages is to decrease (YES in step S1607), then in step S1608, the CPU 2100 skips the scan data determined as a blank to change the layout of the page aggregate including the skipped scan data and data thereafter.

In step S1609, the CPU 2100 updates the total number of pages to be printed, the total number of color pages, and the total number of monochrome pages at the current moment. In step S1610, the CPU 2100 determines whether or not all the pieces of scan data have been confirmed. If there is any scan data that has not yet been confirmed (NO in step S1610), the processing returns to step 51601. If the confirmation of all the pieces of scan data has ended (YES in step S1610), then in step S1611, the CPU 2100 calculates the total amount of money required when the blank skip printing mode is enabled. Then, the CPU 2100 ends this subroutine. At this time, the CPU 2100 only needs to acquire the determination result whether or not there is a page of which the color mode has changed from monochrome to color, even without calculating the total amount of money.

FIG. 17 is a flow chart illustrating the flow of process of calculating the total amount of money required when the blank skip printing mode is disabled. Programs according to the processes illustrated in the flow chart are controlled by the CPU 2100 of the controller unit 200, which sequentially loads programs stored in the ROM 2120 or the hard disk 2130 into the RAM 2110 and executes the programs.

In step S1701, the CPU 2100 calculates, from the total number of pages to be printed, the total number of color pages, and the total number of monochrome pages counted in step S1457, the total amount of money required when the blank skip printing mode is disabled. Then, the CPU 2100 ends this subroutine.

Further, in the flow of FIG. 13, when scanned documents are printed, only if the amount of inserted money is insufficient, the CPU 2100 determines whether or not the blank skip mode has been set. The present exemplary embodiment, however, is not limited to this. That is, the blank skip mode may always be enabled. In this case, if it has been determined that the amount of money required for printing is higher than the amount of money required when the blank skip mode is disabled, the CPU 2100 gives a warning through a user interface (UI) to alert the user.

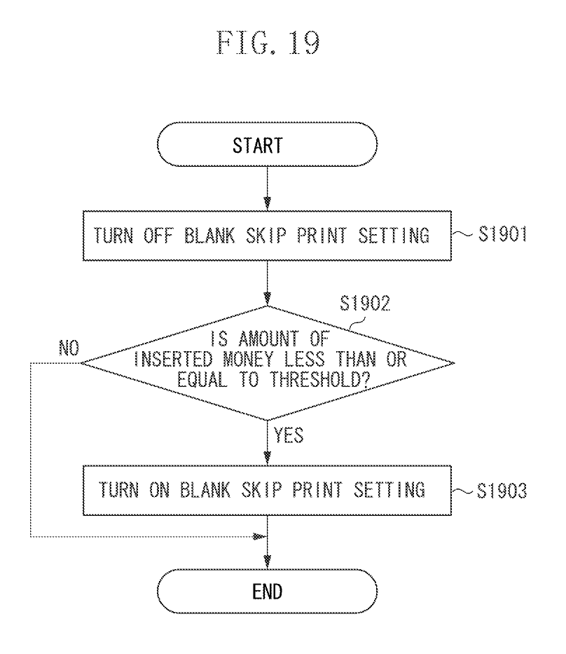

Further, as illustrated below, if the amount of inserted money is less than or equal to a threshold, the blank skip mode may be enabled. FIG. 19 is a flow chart illustrating the flow for switching to determine whether or not the blank skip printing mode is to be automatically enabled based on the amount of inserted money into the coin vending machine 170 by the user. Programs according to the processes illustrated in the flow chart are controlled by the CPU 2100 of the controller unit 200, which sequentially loads programs stored in the ROM 2120 or the hard disk 2130 into the RAM 2110 and executes the programs.

In step S1901, the CPU 2100 disables the blank skip printing setting. In step S1902, the CPU 2100 determines whether or not the amount of inserted money is less than or equal to the amount of money set in advance. If the amount of inserted money is less than or equal to the amount of money set in advance (YES in step S1902), then in step S1903, the CPU 2100 enables the blank skip printing setting, and the flow ends. If the amount of inserted money is greater than the amount of money set in advance (NO in step S1902), the flow ends with the blank skip printing setting remaining disabled.

Based on the above processing, when copy is performed by making a page aggregate setting based on a blank skip printing setting using the blank detection function of an image reading apparatus, it is possible to prevent blank skip printing that reduces the remaining printable amount more than necessary.

That is, it is possible to prevent the situation where, even though print sheets and toner are reduced by performing blank skip printing, the charged price becomes higher than when blank skip printing is not performed.

If not only the charged price but also the number of pages (the number of counts) that the user is allowed to print within a certain period, are set, it is possible to prevent an increase of the amount of reduction in the number of counts.

While the above exemplary embodiments have been described taking an electrophotographic apparatus as an example, an inkjet printer or a thermal printer may also be used, and the scope of the present invention is not limited to the printer. Further, while the above exemplary embodiments have been described taking toner for electrophotographic printing as an example of a recording agent, a recording agent used for printing may be not only toner but also another recording agent such as ink, and the present invention does not limit the type of recording agent.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-186434 filed Sep. 9, 2013, which is hereby incorporated by reference herein in its entirety.

What is claimed is:

1. An image processing apparatus comprising:
a determination unit configured to determine whether each of a plurality of pieces of input image data is image data obtained by reading a blank;
an aggregate unit configured to, in order to lay out any two or more pieces of image data among the plurality of pieces of input image data on a single sheet, aggregate the two or more pieces of image data;
a judgment unit configured to judge a color mode of the two or more pieces of image data aggregated by the aggregate unit;
an acquisition unit configured to acquire a first color mode, which is a result obtained by the judgment unit judging the color mode of the two or more pieces of image data when a first layout is employed, the first layout being obtained by the aggregate unit aggregating the plurality of pieces of input image data, and configured to acquire a second color mode, which is a result obtained by the judgment unit judging the color mode of the two or more pieces of image data when a second layout is employed, the second layout being obtained by the aggregate unit aggregating, among the plurality of pieces of input image data, image data that has not been determined by the determination unit as being obtained by reading a blank; and
a determining unit configured to, according to a result of comparing the first color mode acquired by the acquisition unit with the second color mode acquired by the acquisition unit, determine that the first layout or the second layout is to be employed.

2. The image processing apparatus according to claim 1, further comprising a printing unit configured to print the plurality of pieces of input image data in the layout determined by the determining unit.

3. The image processing apparatus according to claim 1, wherein, if the first color mode acquired by the acquisition unit is monochrome and the second color mode acquired by the acquisition unit is color, the determining unit determines that the first layout is to be employed.

4. The image processing apparatus according to claim 1, wherein, when the first color mode and the second color mode acquired by the acquisition unit are the same, and if it has been determined that the number of sheets which is required for printing the plurality of pieces of input image data is to decrease, the determining unit determines that the second layout is to be employed.

5. The image processing apparatus according to claim 1, wherein the second layout is such that if the plurality of pieces of input image data includes image data obtained by reading a first page that is not a blank, image data obtained by reading a second page that is a blank, and image data obtained by reading a third page that is not a blank, the aggregate unit lays out on a single sheet the image data obtained by reading the first page and the image data obtained by reading the third page.

6. The image processing apparatus according to claim 1, further comprising a unit configured to acquire a first amount of money, which is charged for a process of printing the plurality of pieces of input image data when the first layout is employed as the result of judging the color mode as the first color mode, and a second amount of money, which is charged for a process of printing the plurality of pieces of input image data when the second layout is employed as the result of judging the color mode as the second color mode,
wherein as a result of comparing the acquired amounts of money, if the second amount of money is higher than the first amount of money, the determining unit determines that the first layout is to be employed.

7. The image processing apparatus according to claim 1, further comprising a unit configured to acquire a first amount of money, which is charged for a process of printing the plurality of pieces of input image data when the first layout is employed as the result of judging the color mode as the first color mode, and a second amount of money, which is charged for a process of printing the plurality of pieces of input image data when the second layout is employed as the result of judging the color mode as the second color mode,
wherein as a result of comparing the acquired amounts of money, if the second amount of money is lower than the first amount of money, the determining unit determines that the second layout is to be employed.

8. The image processing apparatus according to claim 1, further comprising a unit configured to acquire a first amount of money, which is charged for a process of printing the plurality of pieces of input image data when the first layout is employed as the result of judging the color mode as the first color mode, and a second amount of money, which is charged for a process of printing the plurality of pieces of input image data when the second layout is employed as the result of judging the color mode as the second color mode; and
a display control unit configured to cause a display unit to display the acquired first amount of money and second amount of money.

9. The image processing apparatus according to claim 1, wherein the aggregate unit lays out the pieces of input image data in an N-in-1 manner or on both sides of a sheet.

10. An image processing method comprising:
determining whether each of a plurality of pieces of input image data is image data obtained by reading a blank;
in order to lay out any two or more pieces of image data among the plurality of pieces of input image data on a single sheet, aggregating the two or more pieces of image data;
judging a color mode of the two or more aggregated pieces of image data;
acquiring a first color mode, which is a result obtained by the judging of the color mode of the two or more pieces of image data when a first layout is employed, the first layout being obtained by aggregating the plurality of pieces of input image data, and acquiring a second color mode, which is a result obtained by the judging of the color mode of the two or more pieces of image data when a second layout is employed, the second layout being obtained by aggregating, among the plurality of pieces of input image data, image data that has not been determined as being obtained by reading a blank; and
according to a result of comparing the acquired first color mode with the acquired second color mode, determining that the first layout or the second layout is to be employed.

11. A computer-readable storage medium storing a computer program for causing a computer to execute the image processing method according to claim 10.

12. The image processing apparatus according to claim 4, wherein, before determining whether the number of sheets which is required for printing the plurality of pieces of input image data is to decrease, the image processing apparatus further operates to: (i) skip image data determined to be a blank or to have no print information; and (ii) change a layout of the two or more aggregated pieces of image data.

13. The image processing apparatus according to claim 5, wherein the image processing apparatus further operates to determine whether a number of sheets which is required for printing the plurality of pieces of input image data is to decrease after the image data obtained by reading the second page that is the blank is skipped and after the aggregate unit changes the layout of the image data obtained by reading the first page and the image data obtained by reading the third page.
